(19) United States
(12) Patent Application Publication
(10) Pub. No.: US 2018/0115175 A1
(43) Pub. Date: Apr. 26, 2018

(54) DISPLAY DEVICE WITH A WIRELESS CHARGING FUNCTION

(71) Applicant: QISDA CORPORATION, Taoyuan City (TW)

(72) Inventor: Hui-Hsien Lin, Taoyuan City (TW)

(21) Appl. No.: 15/695,001

(22) Filed: Sep. 4, 2017

(30) Foreign Application Priority Data
Oct. 26, 2016 (CN) 201610947933.0

(51) Int. Cl. H02J 7/00; H02J 7/02; H02J 50/10; G09G 5/12; G06F 3/147

(52) U.S. Cl. CPC H02J 7/0047; H02J 7/025; H02J 50/10; G09G 5/12; G06F 3/147; H04B 5/0037; G09G 2370/16; G09G 2370/04; G09G 2354/00; G09G 2330/02; H02J 2007/0096

(57) ABSTRACT

A display device includes a display, a wireless charging coil, a wireless charging control module, and a wireless communications module. When the wireless charging control module detects an external device which matches with the wireless charging control module through the wireless charging coil, the wireless charging control module obtains a charging specification of the external device by exchanging messages with the external device through the wireless charging coil, and the wireless charging control module transmits the connection information of the wireless communications module to the external device through the wireless charging coil. The external device establishes a wireless connection to the wireless communications module according to the connection information.

### BACKGROUND OF THE INVENTION

### 1. Field of the Invention

The present invention is related to a display device, especially a display device with a wireless charging function.

### 2. Description of the Prior Art

As the mobile electronic devices being applied to more and more different fields, users are using the mobile electronic devices to retrieve multi-media contents more and more frequently. For example, users may use the mobile electronic devices to browse photos or watch movies. However, to save power and keep portability, the display monitors of the mobile electronic devices are often designed to be smaller, which may not be able to satisfy the users. To present the multi-media content of the mobile electronic device in a larger monitor, in prior art, the user can use a multi-media interface, such as the high definition multimedia interface (MHL), to transmit the multi-media content to a big size display, for example, the television. That is, the mobile electronic device and the display must support the same multi-media interface. However, the requirement of the multi-media interface will also increase the space required by the mobile electronic device. In addition, to support different interfaces, the mobile electronic device has to equip the connectors for different types of interfaces, which further complicate the design of the mobile electronic device.

To solve this issue, the prior art proposes to adopt the wireless communication to transmit the multi-media content, for example, the standard for wireless connections from devices to displays, such as Miracast or Chromecast standard. With the wireless communication, the connectors for different interfaces can be reduced, and the issue of mismatching hardware can also be reduced. However, when using the wireless connection to transmit the multi-media content to the big size displays, the mobile electronic devices may have to download the multi-media content while transmitting the multi-media content in the same time, causing great power consumption and inconvenience.

### SUMMARY OF THE INVENTION

One embodiment of the present invention discloses a display device with a wireless charging function. The display device includes a display, a wireless charging coil, a wireless charging control module, and a wireless communication module.

The wireless charging control module detects an external device matching with the wireless charging control module through the first wireless charging coil, exchanges messages with the external device through the first wireless charging coil, and charges the external device wirelessly through the first wireless charging coil. The wireless communication module establishes wireless communication with the external device.

When the wireless charging control module detects the external device through the first wireless charging coil, the wireless charging control module obtains a charging specification of the external device by exchanging messages with the external device through the first wireless charging coil, and the wireless charging control module exchanges a connection information with the external device through the first wireless charging coil making the wireless communication module establish a wireless communication between the wireless communication module and the external device.

Another embodiment of the present invention discloses a method for operating a display device. The display device includes a display, a wireless charging coil, a wireless charging control module, and a wireless communication module. The method includes the wireless charging control module exchanging messages with an external device through the wireless charging coil to obtain a charging specification of the external device when the wireless charging control module detects the external device matching with the wireless charging control module through the wireless charging coil, the wireless charging control module exchanging a connection information with the external device through the wireless charging coil, and the external device establishing a wireless communication with the wireless communication module according to the connection information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a display device according to one embodiment of the present invention.

FIG. 2 shows a flow chart of the method for operating the display device in FIG. 1.

FIG. 3 shows a display device according to another embodiment of the present invention.

### DETAILED DESCRIPTION

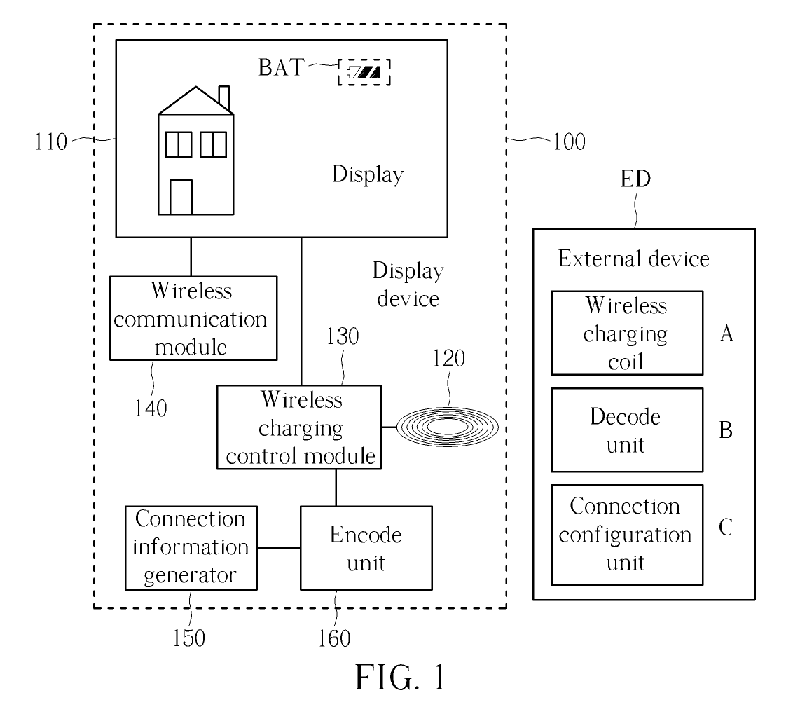

FIG. 1 shows a display device 100 according to one embodiment of the present invention. The display device 100 includes a display 110, a wireless charging coil 120, a wireless charging control module 130, and a wireless communication module 140.

The wireless charging control module 130 can control the wireless charging coil 120 and detect if there's any device matching with the wireless charging control module 130 through the wireless charging coil 120. In FIG. 1, when the wireless charging control module 130 detects an external device ED matching with the wireless charging control module 130 through the wireless charging coil 120, the wireless charging control module 130 can exchange messages with the external device ED through the wireless charging coil. For example, the wireless charging control module 130 can obtain a charging specification of the external device ED, such as the power capacity and the supportable voltage or current of the external device ED, by exchanging messages with the external device ED through the wireless charging coil 120. If the wireless charging control module 130 can support the charging specification of the external device ED, then the wireless charging control module 130 can charge the external device ED through the wireless charging coil 120 wirelessly.

In addition, the wireless communication module 140 can link to the external device ED and obtain the video content from the external device ED to display on the display 110. For example, the wireless communication module 140 and the external device ED can use the wireless connection standard such as Miracast or Chromecast standard to transmit the multi-media content, and the display 110 can present the multi-media content received by the wireless communication module 140. However, in some embodiments, users may also choose or create other types of wireless video transmission standard rather than Miracast or Chromecast standard. Furthermore, users may choose or create other types of wireless connection protocol, such as Bluetooth, to transmit the multi-media content rather than using the protocol of Wi-Fi.

In prior art, if the user wants to use the wireless communication to play the video content on the display device, then the user has to choose the display device to be connected manually to proceed with the connection. However, in FIG. 1, when the wireless charging control module 130 detects the external device ED through the wireless charging coil 120, it usually implies that the external device ED has been disposed at a position very close to the display device 100. Therefore, it is likely that the user is about to display videos through the display device 100. In this case, the wireless charging control module 130 can also transmit the connection information of the wireless communication module 140 to the external device ED through the wireless charging coil 120 so that the external device ED can establish the wireless connection with the wireless communication module 140. Consequently, the external device ED can link to the wireless communication module 140 automatically without manual settings.

In some embodiments, the wireless charging control module 130 can support the Qi wireless charging standard, and the wireless charging control module 130 and external device ED can exchange messages to obtain the charging specification of the external device ED and the connection information of the wireless communication module 140 according to the charging process defined by Qi wireless charging standard.

In the Qi wireless charging standard, the communication between the transmitter and the receiver includes three phases: the selection phase, negotiation phase and power transfer phase. During the selection phase, the transmitter can detect if there's any matched receiver. In this phase, the transmitter and the receiver, that is, the wireless charging control module 130 and the external device ED, can handshake with each other to ensure the communication is stable. In the negotiation phase, the wireless charging control module 130 and the external device ED can exchange messages to negotiate the charging specification to be used. For example, the wireless charging control module 130 can inform the external device ED of the supportable charging specifications, and the external device ED may propose a required charging specification. After the two have confirmed the charging specification, it will enter the power transfer phase. During the power transfer phase, the wireless charging control module 130 can charge the external device ED through the wireless charging coil 120.

During the negotiation phase, since the wireless charging control module 130 and the external device ED can exchange messages, the wireless charging control module 130 can transmit the connection information of the wireless communication module 140 to the external device ED during the negotiation phase defined by Qi wireless charging standard in some embodiments. For example, during the negotiation phase, the external device ED may transmit a query message to the wireless charging control module 130 through the negotiation packet defined by Qi wireless charging standard. The wireless charging control module 130 can store the connection information of the wireless communication module 140 in a negotiation packet according to the query message, and transmit the negotiation packet including the connection information to the external device ED. Consequently, the wireless charging control module 130 can transmit the connection information to the external device ED through the wireless charging coil 120 without using additional hardware. Also, the external device ED can establish the wireless connection to the wireless communication module 140 automatically according to the received connection information without manually settings.

In some embodiments, the query message transmitted by the external device ED includes a header and a message of the negotiation packet, and the query message may ask for information about the peer to peer group identification, the communication channel, the transport layer security (TLS), and the internet protocol (IP), and the wireless charging control module 130 can analyze the packet to response the corresponding information. Consequently, the external device ED can obtain the connection information of the wireless communication module 140.

In FIG. 1, the display device 100 can further include a connection information generator 150 and an encode unit 160. The connection information generator 150 can generate the connection information according to the parameters used by the wireless communication module 140, and the encode unit 160 can package the connection information to generate the packaged connection information according to the Qi wireless charging standard. Consequently, the wireless charging coil 120 can transmit the packaged connection information to the external device ED according to the Qi wireless charging standard. That is, the wireless charging control module 130 can transmit the packaged connection information to the external device ED to exchange the connection information through the wireless charging coil 120.

Furthermore, the external device ED can include a wireless charging coil A, a decode unit B, and a connection configuration unit C. The wireless charging coil A can sense the variations of the magnetic field of the wireless charging coil 120 to generate power, and can receive the packaged connection information transmitted from the wireless charging coil 120. The decode unit B can decode the packaged connection information to obtain the connection information, and the connection configuration unit C can establish the wireless communication with the wireless communication module 140 according to the connection information. After the wireless communication between the display device 100 and the external device ED has been established, the external device ED can inform the display device 100 of the audio content format, the video content format, and the safety mechanism to be used so the display device 110 can obtain the multi-media content from the external device ED through the wireless communication, and display the images according to the requirements of the external device ED.

In some embodiments, the wireless charging control module 130 can exchange the connection information with the external device ED through the wireless charging coil 120 during the negotiation phase defined in the Qi wireless charging standard. In some embodiments, for the convenience of users, the display 110 can also display a user interface so the user can trigger the connection function through the user interface, and the wireless charging control module 130 can exchange the connection information with the external device ED through the wireless charging coil 120 accordingly. Then the display 110 can display the images provided by the external device ED according to the user's command. In some other embodiments, the external device ED can also display the user interface, and the wireless charging control module 130 may receive the packaged connection information from the external device ED through the wireless charging coil 120 accordingly after the user trigger the connection function through the user interface shown in the external device ED.

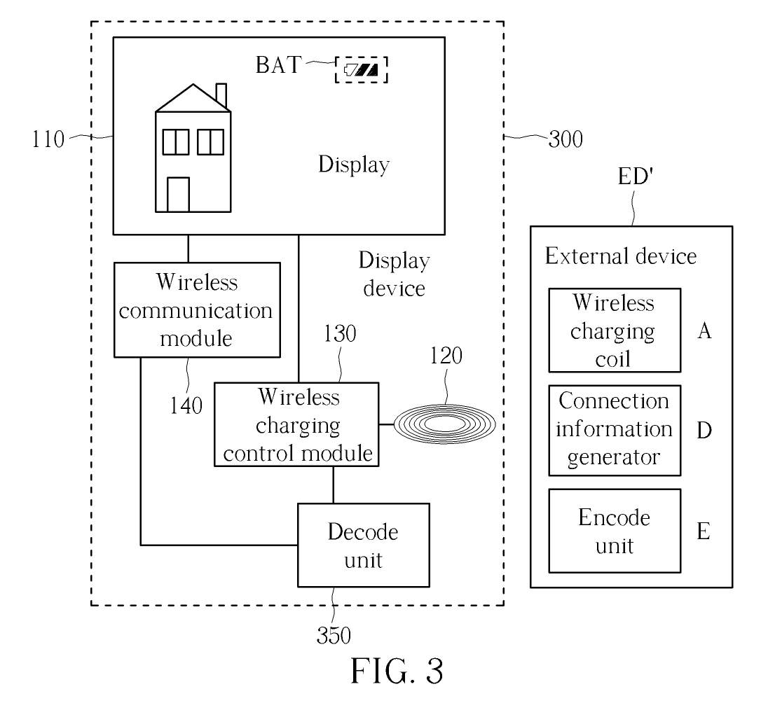

In the embodiment shown in FIG. 1, the connection information generator 150 of the display device 100 can generate the connection information and transmit it to the external device ED, allowing the external device ED to establish the wireless connection to the display device 100. However, FIG. 3 shows a display device 300 and an external device ED′ according to another embodiment of the present invention.

The external device ED′ can include the wireless charging coil A, a connection information generator D, and an encode unit E. The connection information generator D can generate the connection information according to the wireless communication parameters of the external device ED′ and package the connection information to generate the packaged connection information. The wireless charging coil A can sense the variations of the magnetic field of the wireless charging coil 120 to generate power, and can transmit the packaged connection information to the display device 300. The display devices 100 and 300 have similar structures. However, the display device 300 can include a decode unit 350. The decode unit 350 can decode the packaged connection information, and the wireless communication module 140 can establish the wireless communication to the external device ED′ according to the connection information. In other words, the wireless charging control module 130 can receive the packaged connection information transmitted from the external device ED′ through the wireless charging coil 120. In the aforesaid embodiments, the Qi wireless charging standard is used as an example, the similar spirit of exchanging messages for connection information during the wireless charging process can also be applied to other types of wireless charging standards in other embodiments.

Furthermore, the wireless charging control module 130 can also charge the external device ED according to the operation status and the charging specification of the display 110. For example, if the display 110 is currently consuming power for playing music or slides, the display 110 may keep performing the present application and may not provide power to the external device ED temporarily. Later when the display 110 enters an idle state, the wireless charging control module 130 would start to charge the external device ED. Consequently, the low charging efficiency caused by high temperature due to the high power consumption of the display 110 can be avoided.

Similarly, the wireless charging control module 130 can obtain the operation status of the external device ED when exchanging messages with the external device ED. Therefore, the wireless charging control module 130 can charge the external device ED according to the operation status and the charging specification of the external device ED. For example, when the external device ED is in a power consuming state, the wireless charging control module 130 can stop charging the external device ED temporarily and restart to charge the external device ED until the external device ED is back to idle state. Consequently, the low charging efficiency and the short battery life of the external device ED caused by charging and discharging at the same time can be avoided.

When the display device 100 is charging the external device ED, if the wireless charging control module 130 finds the communication quality with the external device ED is not stable, it may imply that the external device ED is not disposed at the right position. In this case, since the display device 100 has both the wireless charging function and the display function, the display 110 may be used to display an icon or words instructing users to adjust the position of the external device ED according to the communication status of the external device ED detected by the wireless charging control module 130 when the wireless charging control module 130 detects the external device ED.

In addition, to let the users be aware of the charging status of the external device ED, in some embodiments, the wireless charging control module 130 can obtain battery status of the external device ED when exchanging messages with the external device ED, and the display 110 can display an icon or words depicting the power level of the external device ED, such as the icon BAT shown in FIG. 1, according to the battery status obtained by the wireless charging control module 130. Consequently, the user can be aware of the battery status of the external device ED by observing the icon BAT shown on the display 110.

In some embodiments, the external device ED can transmit the battery status through the wireless connection with the wireless communication module 140. For example, after the external device ED and the wireless communication module 140 establish the wireless communication, the external device ED can transmit its battery status to the wireless communication module 140 through the wireless communication, and the display 110 can display the icon or words depicting the power level according battery status transmitted from the external device ED, allowing the user to be aware of the charging status of the external device ED.

In addition, in some other embodiments, after the external device ED and the wireless communication module 140 establish the wireless communication, the external device ED can transmit the icon or words depicting the power level to the display device 100 directly through the wireless communication. That is, when the external device ED uses the wireless communication to transmit the multi-media content to the display 110, the multi-media content may have included the icon or words depicting the power level. Also, the external device ED can encode the power status and transmit the encoded package to the display 110, the display 110 can decode the package, obtain the power status of the external device ED and display the icon or words according to the power status.

Since the display device 100 combines the wireless charging function and the display function, the display device 100 can charge the external device ED wirelessly when the user plays the multi-media content of the external device ED on the display device 100. Also, the user can be aware of the battery status of the external device ED by observing the icons shown on the display 110, simplifying the operations of the users. In addition, the display device 100 can transmit the connection information of the wireless communication module 140 to the external electronic devices with the wireless charging coil 120 and the wireless charging control module 130 directly, allowing the external electronic devices to establish wireless connections with the wireless communication module 140 and play the video content on the display device 100 without manual settings.

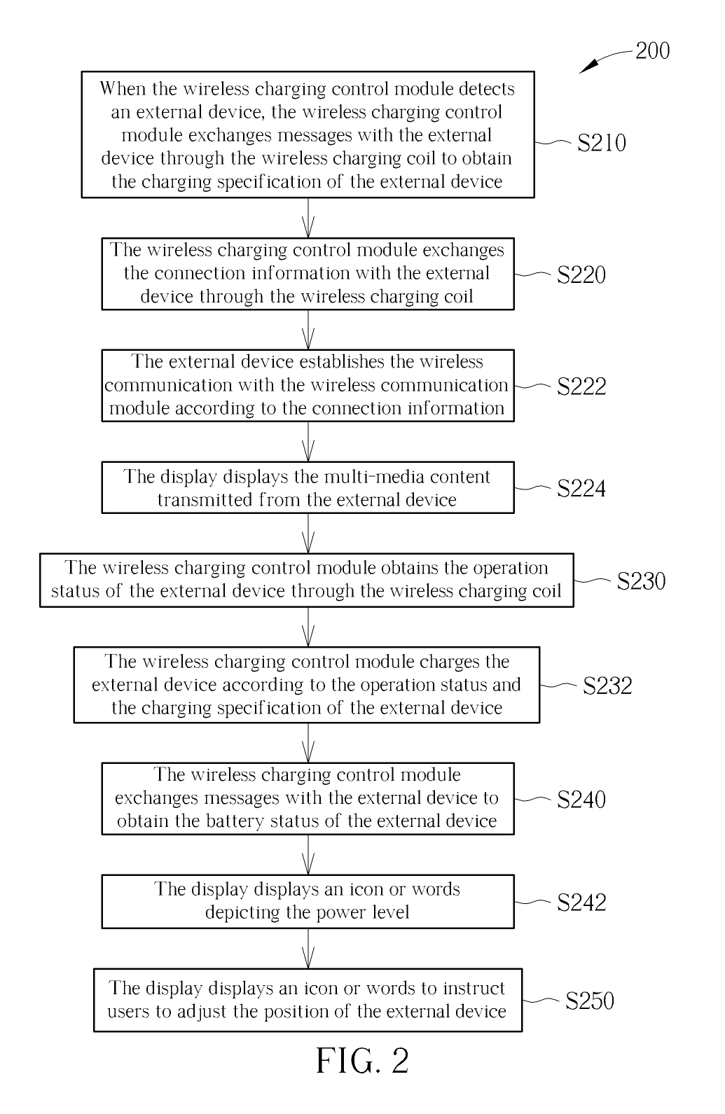

FIG. 2 shows a flow chart of the method 200 for operating the display device 100. The method 200 includes steps S210 to S250 but not limited by the order presented below.

S210: when the wireless charging control module 130 detects an external device ED matching with the wireless charging control module 130 through the wireless charging coil 120, the wireless charging control module 130 exchanges messages with the external device ED through the wireless charging coil 120 to obtain the charging specification of the external device ED;

S220: the wireless charging control module 130 exchanges the connection information with the external device ED through the wireless charging coil 120;

S222: the external device ED establishes the wireless communication with the wireless communication module 140 according to the connection information;

S224: the display 110 displays the multi-media content transmitted from the external device ED through the wireless communication;

S230: the wireless charging control module 130 obtains the operation status of the external device ED by exchanging messages with the external device ED through the wireless charging coil 120;

S232: the wireless charging control module 130 charges the external device ED according to the operation status and the charging specification of the external device ED;

S240: the wireless charging control module 130 exchanges messages with the external device ED to obtain the battery status of the external device ED through the wireless charging coil 120;

S242: the display 110 displays an icon or words depicting the power level; and

S250: the display 110 displays an icon or words to instruct users to adjust the position of the external device ED according to the communication status of the external device ED detected by the wireless charging control module 130.

In some embodiments, the wireless charging control module 130 can follow the Qi wireless charging standard. Therefore, the wireless charging control module 130 can exchange messages with the external device ED during the charging process defined by the Qi wireless charging standard to obtain the charging specification of the external device ED and the connection information of the wireless communication module 140 in steps S210 and S220.

In some embodiments, the connection information stated in step S220 can be generated by the connection information generator 150 of the display device 100. After being encoded by the encode unit 160, the packaged connection information can be transmitted to the external device ED through the wireless charging coil 120. However, in some other embodiments, such as shown in FIG. 3, the connection information can be generated by the connection generator D of the external device ED′. After being encoded by the encode unit E of the external device ED, the packaged connection information will be transmitted to the display device 300. The decode unit 350 of the display device 300 can decode the package to obtain the connection information so the wireless communication module 140 can establish the wireless communication with the external device ED′.

In step S232, the wireless charging control module 130 can charge the external device ED according to the operation status and the charging specification of the external device ED. For example, the wireless charging control module 130 may stop charging the external device ED when the external device ED is consuming power so as to prevent charging and discharging the external device ED at the same time, lowering charging efficiency and shortening battery life. In addition, in some embodiments, the method 200 can also determine whether to charge the external device according to the operation status of the display 110. For example, the wireless charging control module 130 can stop charging the external device ED temporarily when the display 110 is consuming power to avoid excessive power consumption and temperature rising of the display device 100, lowering charging efficiency.

In steps S240 and S242, the wireless control module 130 can obtain the battery status of the external device ED through the wireless charging coil 120, and the display 110 can display the icon or words depicting the power level according to the battery status. Consequently, the user can be aware of the charging status of the external device ED by observing the content displayed on the display 110 directly, making the operation of the display device 100 even more convenient.

In some embodiments, the method 200 can not only obtain the battery status of the external device through the wireless charging control module 130. In some embodiments, the display device 100 may also receive the icon or words through the wireless communication established between the wireless communication module 140 and the external device ED so the display 110 can display the icon or words depicting the power level.

In summary, the display devices provided by the embodiments of the present invention combine the functions of wireless charging and display, so the display devices and the methods for operation the display device can charge the external device wirelessly when the user plays video content on the display device. Also, the display of the display device can show the power level of the external device so the user can always be informed. In addition, with the wireless charging coil and the wireless charging control module, the display device can transmit the connection information of the wireless communication module to the external devices directly so that the external devices can establish the wireless connection to the wireless communication module and play the video content on the display device directly without manual settings.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device with a wireless charging function comprising:
a display;
a first wireless charging coil;
a wireless charging control module configured to detect an external device matching with the wireless charging control module through the first wireless charging coil, exchange messages with the external device through the first wireless charging coil, and charge the external device wirelessly through the first wireless charging coil; and
a wireless communication module configured to establish wireless communication with the external device;
wherein when the wireless charging control module detects the external device through the first wireless charging coil:
the wireless charging control module obtains a charging specification of the external device by exchanging messages with the external device through the first wireless charging coil; and
the wireless charging control module exchanges a connection information with the external device through the first wireless charging coil making the wireless communication module establish a wireless communication between the wireless communication module and the external device.

2. The display device of claim 1 further comprising:
a connection information generator configured to generate the connection information according to wireless communication parameters of the wireless communication module; and
an encode unit configured to package the connection information to generate a packaged connection information;
wherein:
the wireless charging control module transmits the packaged connection information to the external device through the first wireless charging coil; and
the external device comprises:
a second wireless charging coil configured to sense variations of a magnetic field of the first wireless charging coil to generate power, and receive the packaged connection information from the first wireless charging coil;
a decode unit configured to decode the packaged connection information to derive the connection information; and
a connection configuration unit configured to establish the wireless communication between the wireless communication module and the external device according to the connection information.

3. The display device of claim 2, wherein the wireless charging control module exchanges the connection information with the external device through the first wireless charging coil during a negotiation phase in a charging process defined by Qi wireless charging standard.

4. The display device of claim 2, wherein the wireless charging control module exchanges the connection information with the external device through the first wireless charging coil after a user triggers a connection function through a user interface displayed by the external device or the display.

5. The display device of claim 1, wherein:
the external device comprises:
a connection information generator configured to generate the connection information according to wireless communication parameters of the external device;
an encode unit configured to package the connection information to generate a packaged connection information; and
a second wireless charging coil configured to sense variations of a magnetic field of the first wireless charging coil to generate power, and transmit the packaged connection information to the display device, wherein the wireless charging control module receives the packaged connection information transmitted from the second wireless charging coil of the external device through the first wireless charging coil;
the display device further comprises a decode unit configured to decode the packaged connection information; and
the wireless communication module establishes the wireless communication between the wireless communication module and the external device according to the connection information.

6. The display device of claim 5, wherein the wireless charging control module exchanges the connection information with the external device through the first wireless charging coil during a negotiation phase in a charging process defined by Qi wireless charging standard.

7. The display device of claim 5, wherein the wireless charging control module exchanges the connection information with the external device through the first wireless charging coil after a user triggers a connection function through a user interface displayed by the external device or the display.

8. The display device of claim 1, wherein the display obtains a display image source from the external device through the wireless communication.

9. The display device of claim 1, wherein the wireless charging control module is further configured to charge the external device according to an operation status of the display and the charging specification.

10. The display device of claim 1, wherein the wireless charging control module is further configured to obtain an operation status of the external device when exchanging the messages with the external device, and charge the external device according to the operation status and the charging specification of the external device.

11. The display device of claim 1, wherein the wireless charging control module is further configured to obtain a battery status of the external device when exchanging the messages with the external device, and the display displays an icon or words depicting a power level according to the battery status.

12. The display device of claim 1, wherein after the wireless communication between the wireless communication module and the external device is established, the display displays an icon or words depicting a power level transmitted from the external device through the wireless communication.

13. The display device of claim 1, wherein after the wireless communication between the wireless communication module and the external device is established, the display displays an icon or words according to a power level information transmitted from the external device through the wireless communication.

14. The display device of claim 1, wherein the display is further configured to display an icon or words instructing users to adjust a position of the external device according to a communication status of the external device detected by the wireless charging control module when the wireless charging control module detects the external device.

15. A method for operating a display device, the display device comprising a display, a wireless charging coil, a wireless charging control module, and a wireless communication module, the method comprising:
when the wireless charging control module detects an external device matching with the wireless charging control module through the wireless charging coil, the wireless charging control module exchanging messages with the external device through the wireless charging coil to obtain a charging specification of the external device;
the wireless charging control module exchanging a connection information with the external device through the wireless charging coil; and
the external device establishing a wireless communication with the wireless communication module according to the connection information.

16. The method of claim 15, further comprising:
the display displaying a multi-media content transmitted from the external device through the wireless communication.

17. The method of claim 15, further comprising:
the wireless charging control module obtaining an operation status of the external device by exchanging messages with the external device through the wireless charging coil; and
the wireless charging control module charging the external device according to the operation status and the charging specification of the external device.

18. The method of claim 15, further comprising:
the wireless charging control module exchanging messages with the external device to obtain a battery status of the external device through the wireless charging coil; and
the display displaying an icon or words depicting the power level according to the battery status.

19. The method of claim 15, further comprising:
the display displaying an icon or words to instruct users to adjust a position of the external device according to a communication status of the external device detected by the wireless charging control module when the wireless charging control module detects the external device.

20. The method of claim 15, wherein the wireless charging control module exchanging the connection information with the external device through the wireless charging coil is during a negotiation phase in a charging process defined by Qi wireless charging standard.
